(19) United States
(12) Patent Application Publication
(10) Pub. No.: US 2024/0016341 A1
(43) Pub. Date: Jan. 18, 2024

(54) CUTTING INSERT

(71) Applicant: Mohib Saddruddin Ebrahim, Vancouver (CA)

(72) Inventor: Mohib Saddruddin Ebrahim, Vancouver (CA)

(21) Appl. No.: 18/207,270

(22) Filed: Jun. 8, 2023

Related U.S. Application Data
(60) Provisional application No. 63/389,981, filed on Jul. 18, 2022.

(51) Int. Cl. A47J 47/00; A47J 47/16

(52) U.S. Cl. CPC A47J 47/005; A47J 47/16

(57) ABSTRACT

The presently disclosed subject matter relates to a cutting insert designed to fit in a traditional food container, specifically the food container's lid. The cutting insert comprises an upward facing surface and downward facing surface. The upward facing surface and downward facing surface define a thickness therebetween and a perimeter that extends between them. The thickness of the cutting insert is designed so that its upward facing surface, on which food may be placed, is raised above the rims of the lid in which it is placed, thus enabling a user to easily cut food placed on the cutting insert. Thus, the cutting insert provides a raised, substantially planar, surface usable for placing food, and cutting, on it. Additionally, the cutting insert when positioned inside the lid, does not prevent a user from releasably securing the lid to the food container's body, and thereby storing food placed on the cutting insert inside the food container, while the food container is maintained in an upside-down position.

### TECHNICAL FIELD

The presently disclosed subject matter relates generally to a cutting insert designed to fit in a standard food container's lid. More specifically, the present disclosure relates to a cutting insert which fits in a food container's lid while enabling a user the option of releasably securing the food container's lid to the food container's body.

### BACKGROUND

The present disclosure relates to a cutting insert designed to fit in a traditional, or commercially available, food container's lid. Many food items, for example cheese or cakes, are best kept on a flat surface, suitable for cutting or slicing, while covered for storage. This provides the convenience of having the food readily available on a cutting surface, rather than, for an example, in a bottom of a container where a user has to struggle to reach, retrieve, or cut it properly. Furthermore, having the food pre-placed on a cutting surface prevents knife damage to the food-container's lid if the food container is used upside down and the food placed directly in the lid, rather than the container.

Some specialized food containers, which are designed for placing and keeping food on a cutting surface, exist in the field. Well known examples of such specialized containers include a butter dish or a cake container. However, such available specialized containers are often expensive, and in fact cost-prohibitive, and furthermore, many times these specialized containers do not fit in dimensions to the food items which one wishes to store. Furthermore, these specialized food containers have custom fit lids and containers, so the cutting surface can only be used with the matching lid.

On the other hand, traditional food containers of every size and dimensions are readily available and affordable. Those food containers simply include a container body, in which the food is stored, and a lid which can be releasably secured to the body. The presently disclosed cutting insert practically and easily transforms any such traditional food container into a specialized food container, thereby solving the above-described problems of cost and availability.

### SUMMARY

In accordance with the present invention, various embodiments of the presently disclosed cutting insert 1. A cutting insert designed for fitting in a food container lid, the cutting insert comprising an upward facing surface and downward facing surface and a perimeter that extends between the upward facing surface and the downward facing surface.

In some embodiments, the upward facing surface and the downward facing surface are substantially planar.

In some embodiments, the cutting insert is of a predetermined shape. In some embodiments, the predetermined shape is selected from a group comprising a square, rectangle, circle, oval, or other non-standard food container shape.

In some embodiments, the cutting insert is designed to have a predetermined thickness defined between the upward facing surface and downward facing surface.

In some embodiments, the downward facing surface is concave, wherein the depression is centered at the center of the downward facing surface and conforms to the shape of the downward facing surface.

In some embodiments, the downward facing surface is concave; and wherein the depression is centered at the center of the downward facing surface and the shape of the depression id selected from a group comprising a square, rectangle, circle, or oval.

In some embodiments, the downward facing surface is coated with, or fashioned of, a material having a high coefficient of friction.

In some embodiments, the perimeter is coated with, or fashioned of, a material having a high coefficient of friction.

In some embodiments, the upward facing surface comprises at least one groove formed proximal to, and along, at least one portion of a perimeter of the upward facing surface.

In some embodiments, the upward facing surface comprises an arcuate groove formed proximal to, and along, a perimeter of the upward facing surface.

In some embodiments, the cutting insert comprises at least one aperture proximal to said cutting insert perimeter; the at least one aperture sized to receive one or more fingers of a user for installing and removing said cutting insert from the food container lid.

In some embodiments, at least one side of the perimeter comprises at least one indentation; the at least one indentation sized to receive one or more fingers of a user for installing and removing said cutting insert from the food container lid.

In some embodiments wherein the cutting insert is a square or rectangle, two sides of the cutting insert, which are opposing and substantially parallel, each comprise said at least one indentation.

In some embodiment, at least one side of the downward facing surface comprises at least one indentation positioned at its edge; the at least one indentation sized to receive one or more fingers of a user for installing and removing said cutting insert from the food container lid.

In some embodiments, wherein the cutting insert is a square, two sides of the downward facing surface, which are opposing and substantially parallel, comprise said at least one indentation.

A method of using the presently disclosed cutting insert to store and cut food comprises the steps of:
a) placing the cutting insert inside the food container's lid so that the cutting insert is within the perimeter of the lid's inner rim;
b) placing a food item on the cutting insert;
c) releasably securing the food container lid to the food container body wherein food container is in an upside-down position, and thus storing the food inside the food container;
d) as needed, releasing the food container body from the food container lid to cut food placed on the cutting insert or to remove the cutting insert and food placed upon it from the food container lid.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a top view of an example of the presently disclosed cutting insert;

FIG. 2 illustrates a perspective top view the example of the presently disclosed cutting insert of FIG. 1;

FIG. 3 illustrates a perspective bottom view the example of the presently disclosed cutting insert of FIG. 1;

FIG. 4 illustrates a perspective view of an example of a food container;

FIG. 5 illustrates a perspective view of the example of the presently disclosed cutting insert next to the food container's lid of FIG. 3;

FIG. 6 illustrates a perspective view of the example of the presently disclosed cutting insert inside the food container's lid;

FIG. 7a illustrates a sectional view of the example of the presently disclosed cutting insert inside the food container's lid wherein a knife blade is placed on the cutting insert;

FIG. 7b illustrates a sectional view of the example of the presently disclosed cutting insert inside the food container's lid wherein a knife blade and a food item are placed on the cutting insert;

FIG. 7c illustrates a sectional view of the example of the presently disclosed cutting insert inside the food container's lid wherein a knife blade is placed on the cutting insert;

FIG. 8 illustrates a perspective view of the example of the presently disclosed cutting insert inside the food container's lid wherein a knife blade and a food item are placed on the cutting insert;

FIG. 9 illustrates a perspective view of the example of the presently disclosed cutting insert inside the food container's lid wherein a food item is placed on the cutting insert and the food container's body is releasably secured to the lid;

FIG. 10a illustrates a top perspective view of an example of the presently disclosed cutting insert wherein the cutting insert is circular;

FIG. 10b illustrates a top perspective view of an example of the presently disclosed cutting insert wherein the cutting insert is squarish;

FIG. 10c illustrates a top perspective view of an example of the presently disclosed cutting insert wherein the cutting insert is oval;

FIG. 11a illustrates a bottom perspective view of an example of the presently disclosed cutting insert wherein the downward facing surface is concave;

FIG. 11b depicts a sectional view of the cutting insert of FIG. 11a;

FIG. 12a illustrates a top perspective view of an example of the presently disclosed cutting insert wherein the downward facing surface comprises a material having a high coefficient of friction;

FIG. 12b depicts a side view of the cutting insert of FIG. 12a;

FIG. 13a illustrates a top perspective view of an example of the presently disclosed cutting insert wherein the perimeter comprises a material having a high coefficient of friction;

FIG. 13b depicts a sectional view of the cutting insert of FIG. 13a;

FIG. 14a illustrates a top perspective view of an example of the presently disclosed cutting insert wherein the cutting insert comprises a groove formed along one portion of a perimeter;

FIG. 14a illustrates a top perspective view of an example of the presently disclosed cutting insert wherein the cutting insert comprises a groove formed along its perimeter;

FIG. 15a illustrates a top perspective view of an example of the presently disclosed cutting insert wherein the downward facing surface comprises at least one indentation, or groove, positioned at its edge;

FIG. 15b illustrates a bottom view of the cutting insert of FIG. 15a;

FIG. 16 illustrates a top perspective view of an example of the presently disclosed cutting insert wherein the cutting insert comprises apertures; the apertures designed for receiving a user's fingers;

FIG. 17a illustrates a top perspective view of an example of the presently disclosed cutting insert wherein opposite side of the perimeter comprise indentations; and,

FIG. 17b illustrates a top view of the cutting insert of FIG. 17a.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a cutting insert designed to fit inside a lid of a traditional/commercially-available food container and provide a raised, substantially planar, surface, usable for placing food on it, and if desired cutting food positioned on it. The cutting insert is designed to fit inside the perimeter of a food container's lid (also referred to herein as “lid”) inner rim. The thickness of the cutting insert is designed so that its upward facing surface, on which food may be placed, is raised above the inner and outer rims of the lid, thus enabling a user to easily cut food placed on the cutting insert even when a knife's blade is longer than the width of the lid without touching or damaging the lid's rims while cutting. Additionally, the cutting insert when positioned inside the lid, does not prevent a user from releasably securing the lid to the food container's body (also referred to herein as “body”). To use the cutting insert, a user places it inside a desired food container wherein the cutting insert fits inside the lid's inner rim perimeter. A user than may position food upon the cutting insert, as desired. To store the food, a user releasably secures the body to the lid, wherein the food container is in an upside-down position. To consume, or cut the food, a user releases the body from the lid while the food container is maintained in an upside-down position and may cut the food while it rests on the cutting insert, still within the lid. A user may also remove the cutting insert with food on it to serve the food, and when needed, re-place the cutting insert, with any food remains, inside the lid, and if desired re-secure it to the body for continued storage. The cutting insert may also be easily removed from the lid for cleaning and subsequent use.

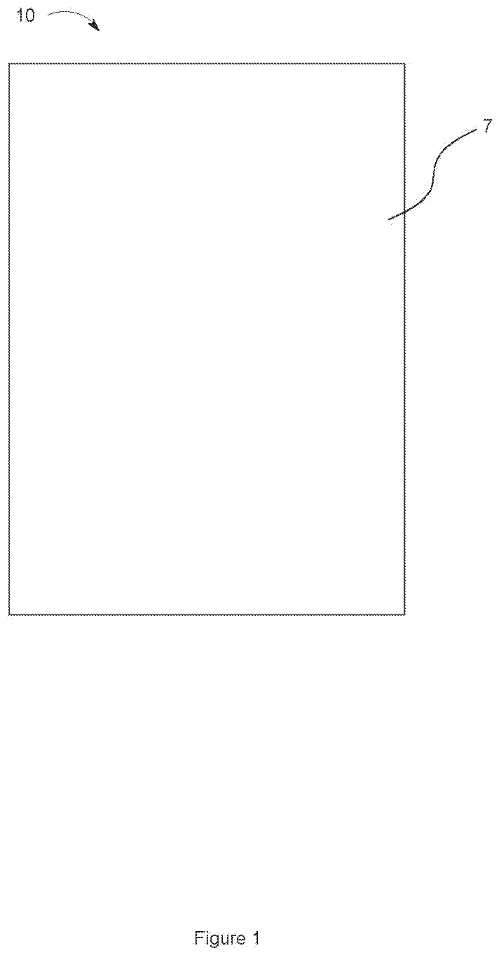

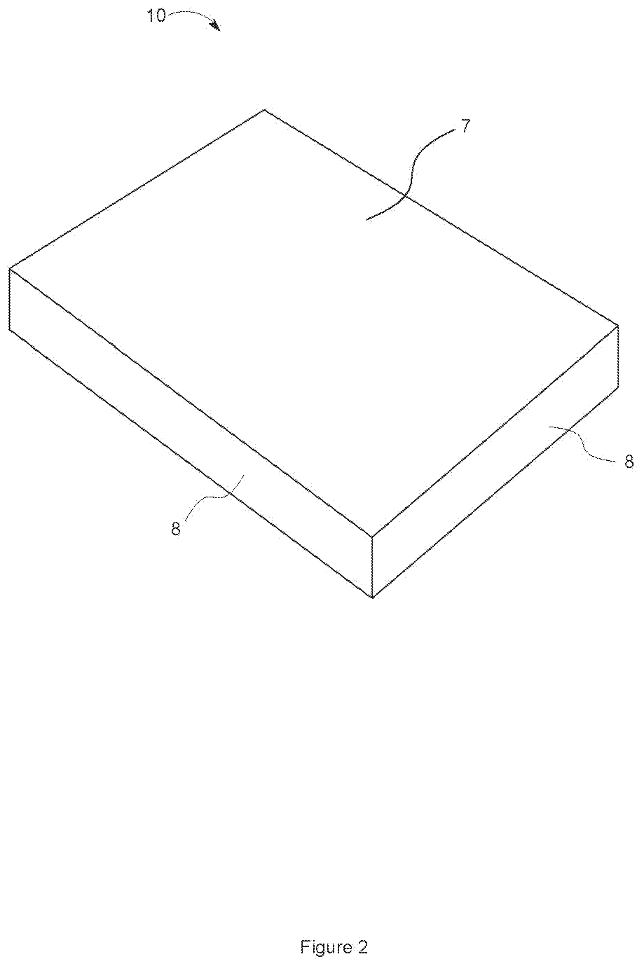

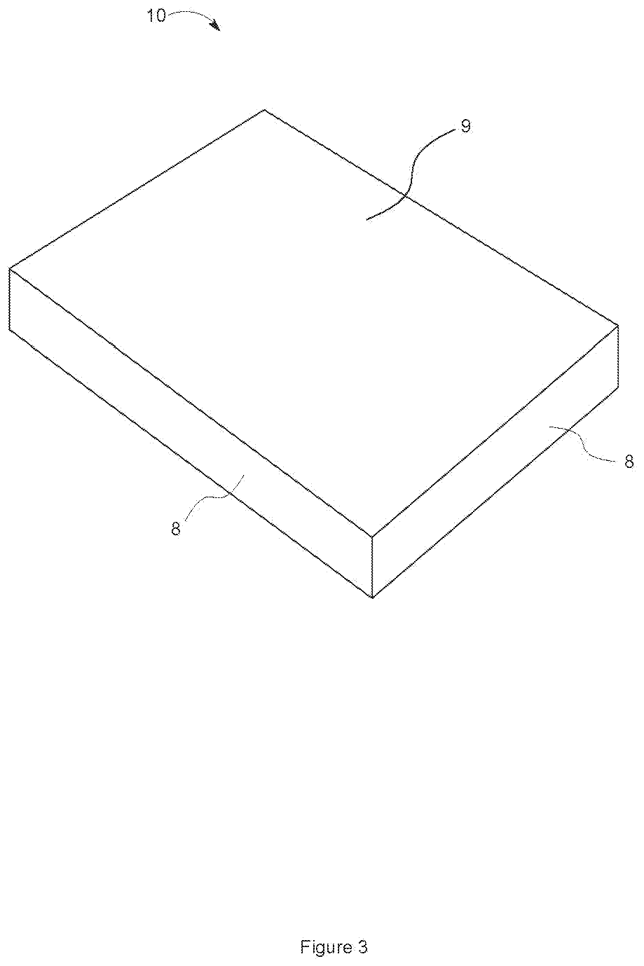

Referring now to FIGS. 1, 2, and 3, top view, perspective top view, and perspective bottom view of an example of the presently disclosed cutting insert 10 are shown, respectively. The cutting insert 10 comprises an upward facing surface 7 and downward facing surface 9. The an upward facing surface 7 and downward facing surface 9 define a thickness therebetween, and a perimeter 8 extends between the upward facing surface 7 and the downward facing surface 9.

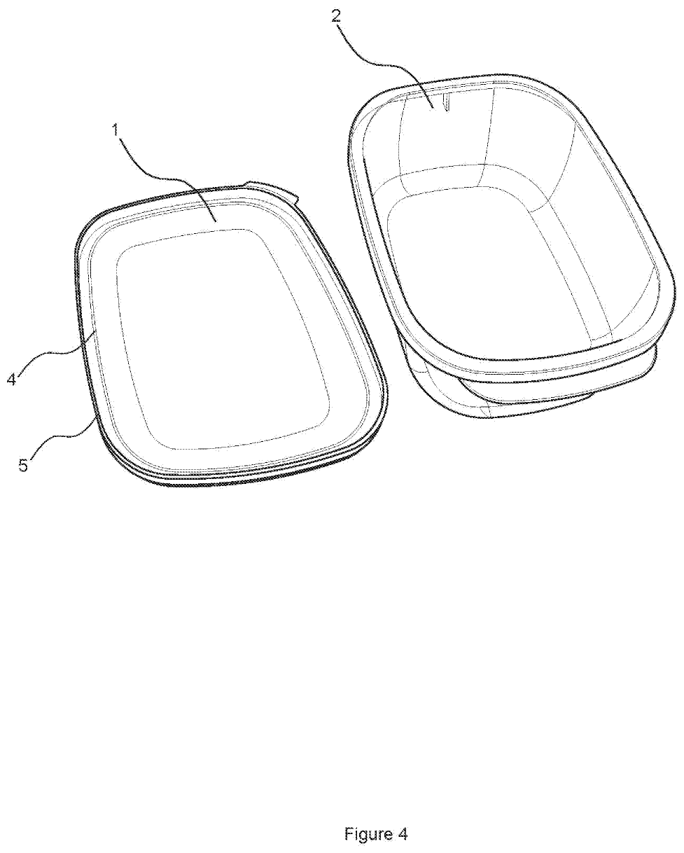

The presently disclosed cutting insert 10 is designed to fit inside a lid 1 of a traditional/commercially-available food container 1, 2, an example of which is depicted in FIG. 4. Such food containers 1, 2 are affordable and readily available in a variety of shapes and sizes. Accordingly, the presently disclosed cutting insert 10 may be of various shapes and sizes. Additionally, the presently disclosed cutting insert 10 can be used with a food container 1, 2 fashioned of any material, such as, without limitation, glass, tin, plastic, wood, or combinations thereof. In the example of FIGS. 1-9, the presently disclosed cutting insert 10 is shaped as a rectangle, or substantially rectangular. However, in other embodiments the cutting insert 10 may have, without limitation, the shape of a square (FIG. 10b), squarish (FIG. 10b), circle (FIG. 10a), oval (FIG. 10c), or other, non-standard shape.

In the embodiments that the presently disclosed cutting insert is shaped as a rectangle or square, the length of the rectangle or square sides may be, as an unlimiting example, in the range of about 2-12 inches. More specifically, the length of the rectangle or square sides may be, or be about, without limitation, 2, 2.5, 3, 3.5, 4, 4.5, 5, 5.5, 6, 6.5, 7, 7.5, 8, 8.5, 9, 9.5, 10, 10.5, 11, 11.5, or 12 inches. In the embodiments that the presently disclosed cutting insert is shaped as a circle or oval, the length of the circle or oval diameters may be, as an unlimiting example, in the range of about 2-12 inches. More specifically, the length of the circle or oval diameters may be, or be about, without limitation, 2, 2.5, 3, 3.5, 4, 4.5, 5, 5.5, 6, 6.5, 7, 7.5, 8, 8.5, 9, 9.5, 10, 10.5, 11, 11.5, or 12 inches. In the embodiments that the presently disclosed cutting insert is shaped to fit other, non-standard shaped food containers, where overall sizes may be, as an unlimiting example, in the range of about 2-12 inches in width and length. More specifically, the overall length and width may be, or be about, without limitation, 2, 2.5, 3, 3.5, 4, 4.5, 5, 6, 6.5, 7, 7.5, 8, 8.5, 9, 9.5, 10, 10.5, 11, 11.5, or 12 inches. In any of the embodiments of the presently disclosed cutting insert 10, its corners or its sides, or both its corners and sides, may be rounded.

Referring now to FIG. 4, a food container 1, 2 which is an example of traditional/commercially-available food containers is illustrated. Generally, such food container 1, 2 comprises a body 2 and a lid 1, and a user is able to reversibly secure the lid 1 to the body 2. For the purpose of the present disclosure, by “food container” it is meant any container that could be used to store food. The lid 1 may comprise an inner rim 4 and an outer rim 5. The inner rim 4 and the outer rim 5 define a space between them into which the upper edge of the body 2 is inserted when the lid 1 is reversibly secured to the body 2. FIG. 5 depicts the presently disclosed cutting insert 10 next to the lid 1. The cutting insert's 10 perimeter 8 is designed to fit within the perimeter of the lid's inner rim 4. Thus, the cutting insert 10 when fitted inside the lid 1 does not interfere with the releasable attachment of the lid 1 to the body 2.

In some embodiments, the upward facing surface 7 and downward facing surface 9 are identical or similar, and thus the cutting insert 10 may be positioned inside the lid 1 with either the upward facing surface 7 or the downward facing surface 9 placed upon the lid 1 (facing the lid 1). In some other embodiments, which will be discussed below, the upward facing surface 7 and downward facing surface 9 are not identical. FIG. 6 depicts the cutting insert 10 positioned inside the lid 1, within the perimeter of the inner rim 4, and with the downward facing surface 9 placed upon the lid. In some embodiments (shown), the cutting insert 10 fits within the inner rim 4 but does not have the same contour as the inner rim 4. However, in some other embodiments (not shown), the contour of the perimeter 8 matches the contour of the inner rim 4.

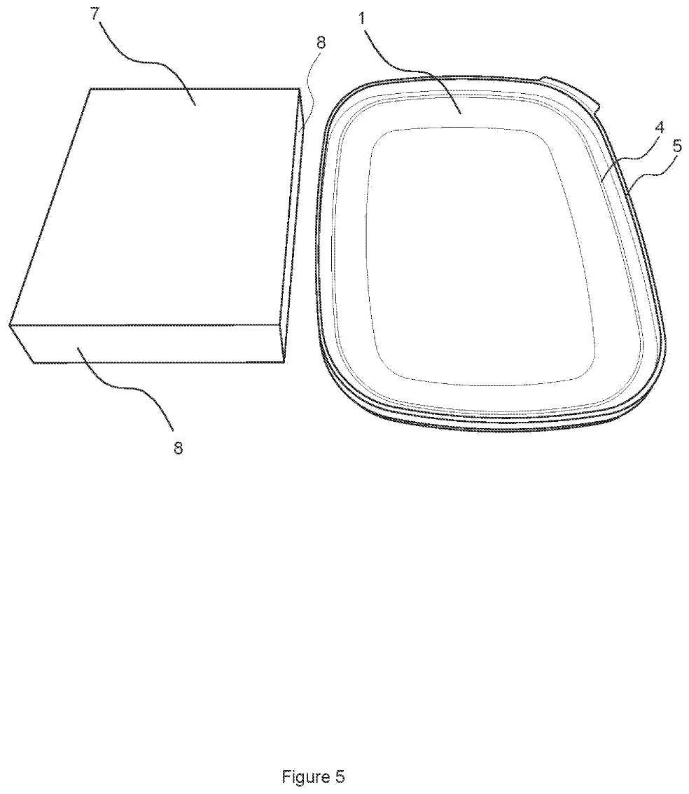

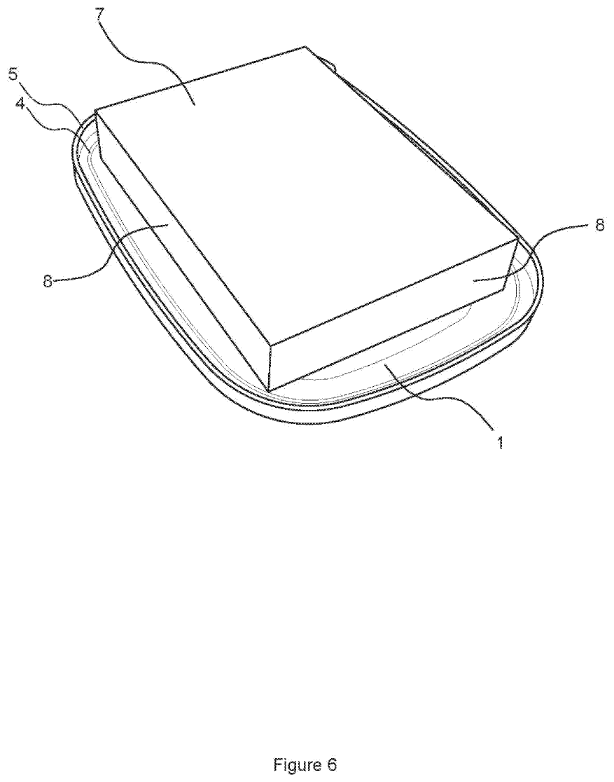

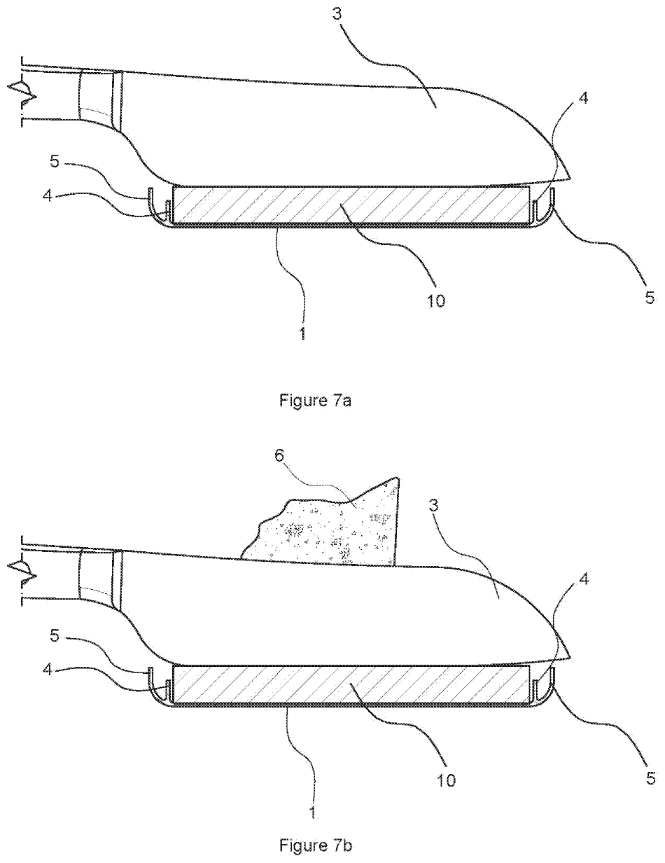

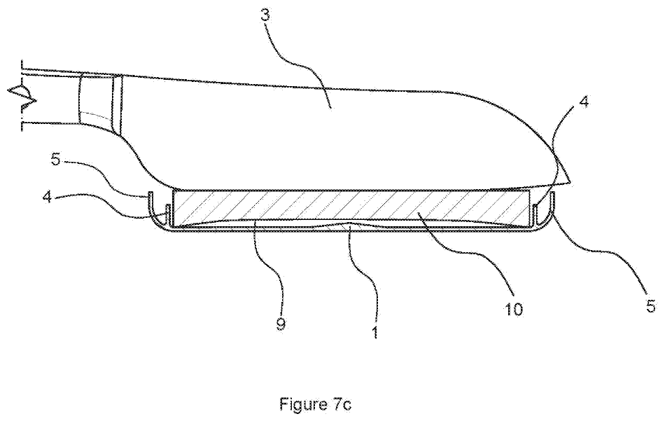

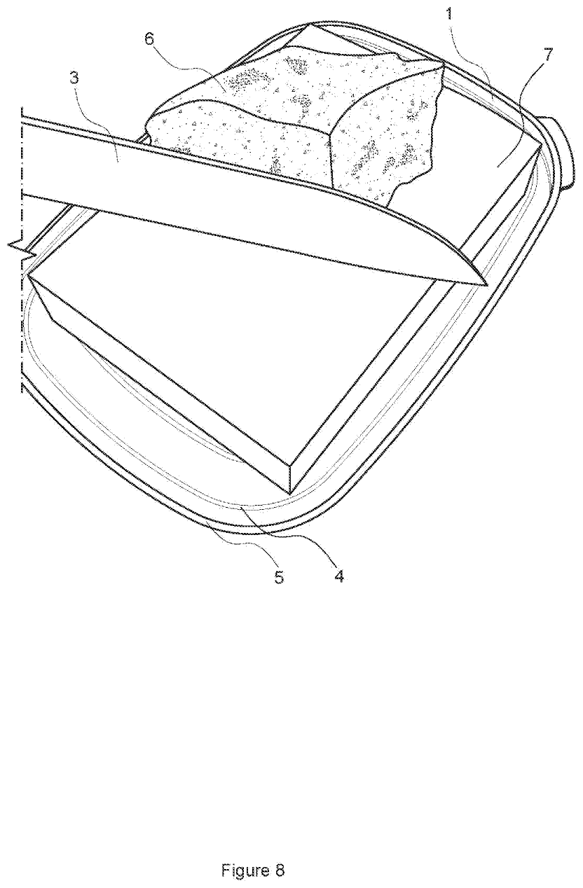

Next, FIGS. 7a-c illustrate a sectional view of the cutting insert 1 positioned inside a lid 1 within the perimeter of the inner rim 4, and a blade 3 of a knife (partly shown) resting upon the upward facing surface 7. FIG. 7b also depicts a food 6 placed, according to the cutting insert's intended use, on the cutting insert 1. In a preferred embodiment, the thickness, or height, of the presently disclosed cutting insert 10 is greater than the height of the lid's both inner rim 4 and outer rim 5. This is important in order to allow horizontal placement of a knife blade 3 upon the upward facing surface 7 even when the blade 3 is longer than the width or length of the lid 1, and so its unhindered use for cutting food 6 and avoidance of damage to the rims while cutting. The cutting insert's 10 thickness thus comprises any suitable measure of thickness that raises the upward facing surface 7 above the rim. As an unlimiting example, the cutting insert 10 thickness may be in the range of about 0.25-2 inches. More specifically, the thickness of the cutting insert 10 may be, or be about, without limitation, 0.25, 0.5, 0.75, 1, 1.25, 1.5, 1.75 or 2 inches. FIG. 8 illustrates a perspective view of a long knife blade 3 resting horizontally on the upward facing surface 7 and ready to be put to use to cut food 6 on the cutting insert 10 which is positioned inside the lid 1.

Finally, the food 6 can be conveniently stored positioned on the cutting insert 10, and specifically in the example of FIG. 8, on the upward facing surface 7. All a user has to do is secure the body 2 to the lid 1 which contains the cutting insert 10 and food 6. The food container 1, 2, is then releasably closed in an upside-down position and is ready to be stored in its upside-down position.

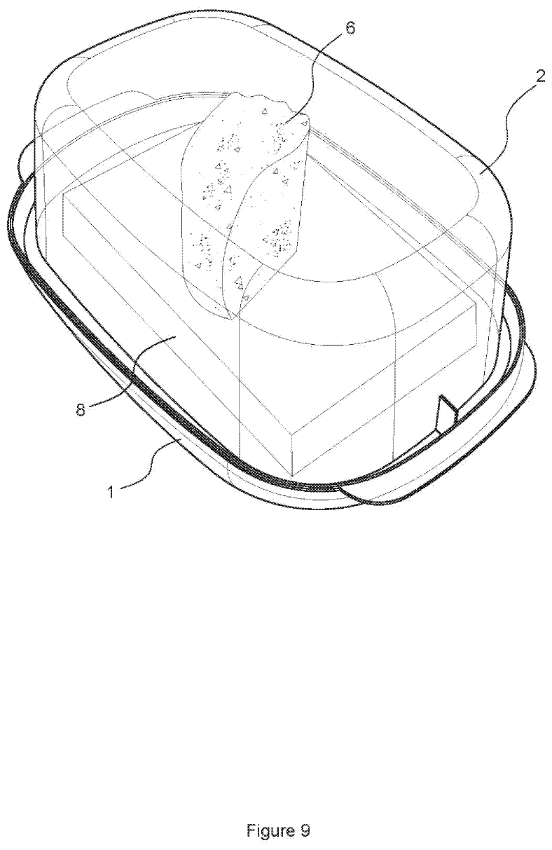

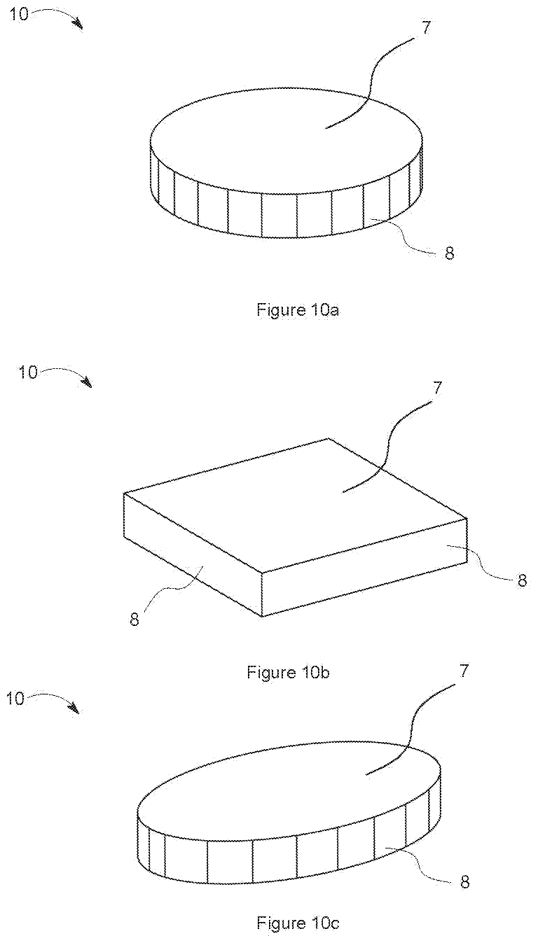

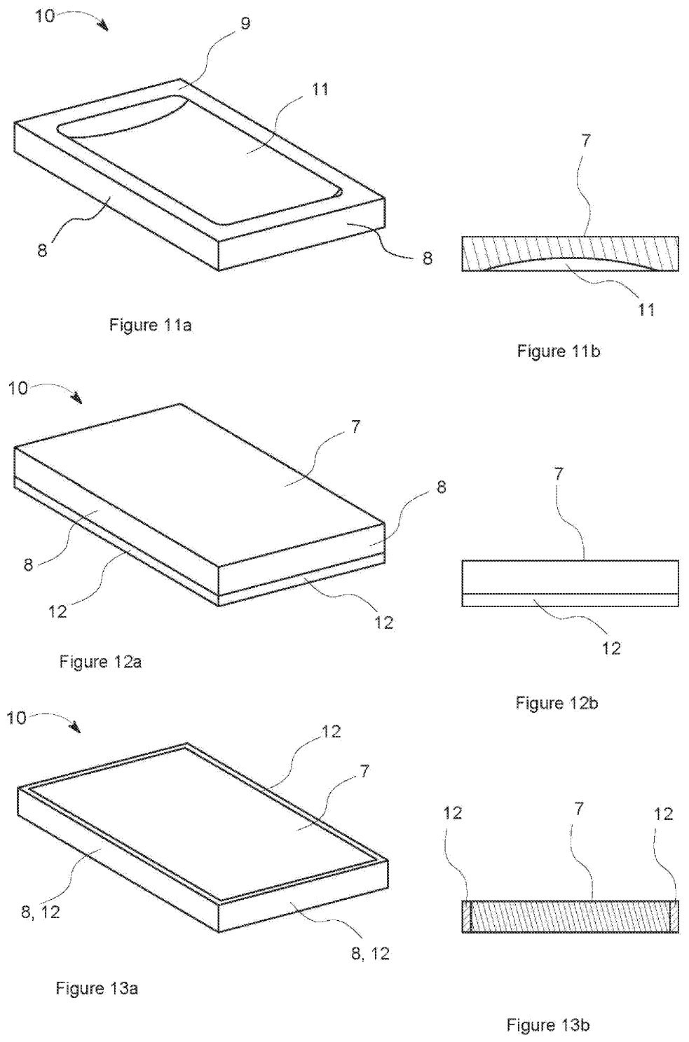

In some embodiments of the presently disclosed cutting insert 10, the upward facing surface 7, the downward facing surface 9, or both, are substantially planar. In some other embodiments, depicted in FIGS. 7c, 11a, 11b, the downward facing surface 9 is concave and the depression 11 is centered at the center of the downward facing surface 9 and conforms to the shape of the downward facing surface 9. Thus, the presently disclosed cutting insert 10 can be fitted inside a lid 1 which has an air seal, or any other structural element, which necessitate a protrusion on the inside surface of the lid 1, on which the downward facing surface 9 rests. As illustrated in FIG. 7c, the optional depression 11 in the downward facing surface 9 enables it to fit in a stable manner inside the lid 1 while not resting, or rocking, on the protrusion. FIGS. 11a and 11b feature a rectangularly shaped cutting insert 10 which comprises a substantially rectangular depression 11 on its downward facing surface 9.

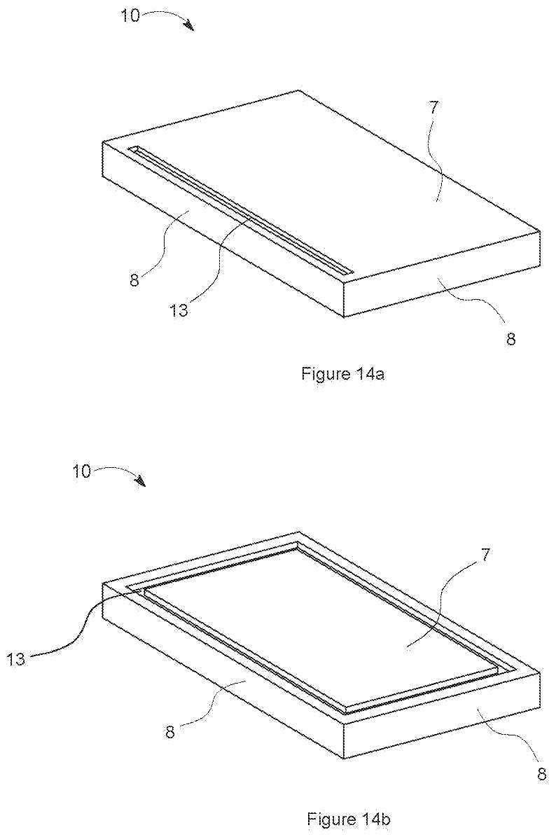

In some embodiments of the presently disclosed cutting insert 10, the upward facing surface 7 comprises at least one groove/channel 13, for catching liquids, formed proximal to, and along, at least one portion of the perimeter (edge) of the upward facing surface 7. FIG. 14a illustrates and example of the presently disclosed cutting insert 10 which comprises a groove/channel 13 positioned along one side of the perimeter. In some other embodiments, the upward facing surface 7 comprises one arcuate groove/channel 13, for catching liquids, formed proximal to, and along, the entirety of the perimeter (edge) of the upward facing surface 7, as featured in FIG. 14b.

In some embodiments of the presently disclosed cutting insert 10, it is desired that there is a high coefficient of friction between the cutting insert 10 and the lid 1, when the cutting insert 10 is positioned inside the lid 1, to minimize movement of the cutting insert 10 against the lid 1 when food 6 placed on the cutting insert 10 is being cut. Therefore, in some embodiments of the presently disclosed cutting insert 10, the downward facing surface 9 is coated with, or fashioned of, a material having a high coefficient of friction 12 (FIGS. 12a and 12b). In some other embodiments, the perimeter 8, or a portion of the perimeter 8, is coated with, or fashioned of, a material having a high coefficient of friction 12 (FIGS. 13a and 13b). In yet some other embodiments, the corners of the perimeter 8 are coated with, or fashioned of, a material having a high coefficient of friction 12. In some embodiments, any portion of the cutting insert 10 including the downward facing surface 9, the perimeter 8 or a portion of the perimeter 8, corners of the perimeter 8, or combinations thereof, are coated with, or fashioned of, a material having a high coefficient of friction 12. Material having a high coefficient of friction 12 includes, without limitation, silicone type material, rubber type material, or any type of silicone rubber.

In some embodiments of the presently disclosed cutting insert 10, for example when the cutting insert 10 fits closely within the perimeter of the inner rim 4, it is desired for a user to be able to remove the cutting insert 10, possibly along with any food 6 on it, easily from the lid 1. Therefore, in some embodiments, the presently disclosed cutting insert 10 comprises at least one aperture 15 at a predetermined location proximal to the cutting insert 10 perimeter 8, sized to receive one or more fingers of a user for installing and removing the cutting insert 10 from the food container lid 1. An example of this embodiment is illustrated in FIG. 16, depicting a rectangular cutting insert 10 which comprises four apertures 15, each aperture 15 positioned proximal to a corner. In some other embodiments, each aperture 15 may be positioned substantially in the middle of a side of a rectangle or square, in some embodiments, in such a manner that the apertures of parallel opposite sides of the cutting insert 10 oppose each other. Thus, allowing a user to use two fingers, each one inserted in an aperture 15, to handle the cutting insert 10. In some embodiments, the cutting insert 10 comprises two apertures 15, each positioned proximal to the perimeter 8 and substantially in the middle of a side of a rectangular or squarish cutting insert 10, wherein the sides are parallel. In some other embodiments, the cutting insert 10 comprises two apertures 15, each positioned proximal to the perimeter 8 and opposing each other wherein the cutting insert 10 is oval (FIG. 10c) or circular (FIG. 10a).

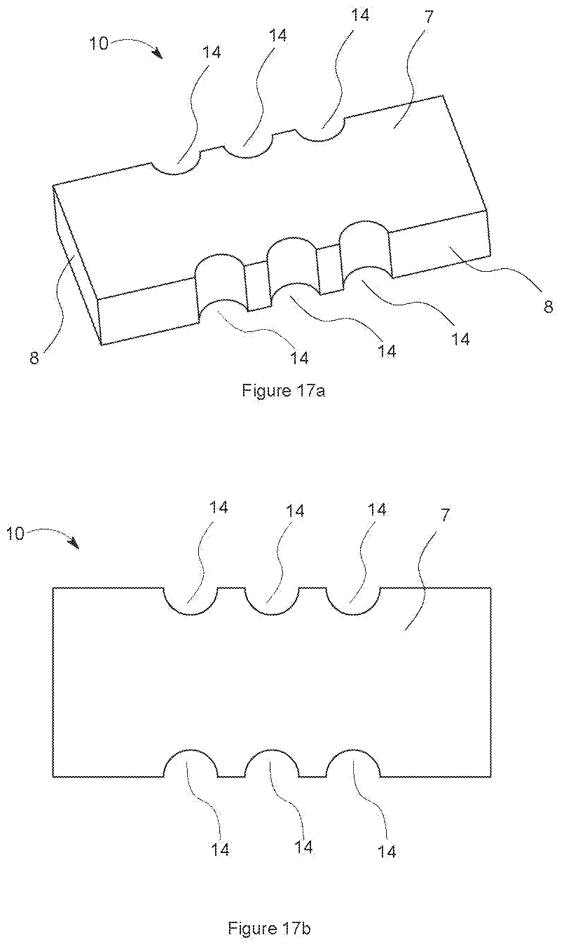

In some other embodiments, the perimeter 8 comprises at least one indentation 14 sized to receive/fit one or more fingers of a user for installing and removing said cutting insert from the food container lid 1 (FIGS. 17a and 17b). For example, any two opposite sides of the perimeter 8 may have at least one indentation 14 such as described above. As a specific example, the at least one indentation 14 on one of the said opposite sides may be designed to receive/fit a user thumb, while the at least one indentation 14 on the second opposite side may be designed to receive/fit one or more non-thumb user finger/s. In some embodiments, the above-mentioned at least one indentation 14 comprises, or coated with, a material having a high coefficient of friction 12. In the example depicted in FIGS. 17a and 17b, the rectangular cutting insert 10 comprises three indentations 14 positioned proximal to the perimeter 8 and substantially in the middle of a side, wherein the parallel side also comprises three indentations 14 positioned proximal to the perimeter 8 and substantially at its middle, whereas the indentations 14 substantially oppose each other. Thus, allowing a user to use his or her fingers, place in the indentations 14 as desired, to handle the cutting insert 10. In some other embodiments, the cutting insert 10 comprises two indentations 14, each positioned proximal to the perimeter 8 and opposing each other wherein the cutting insert 10 is oval (FIG. 10c) or circular (FIG. 10a).

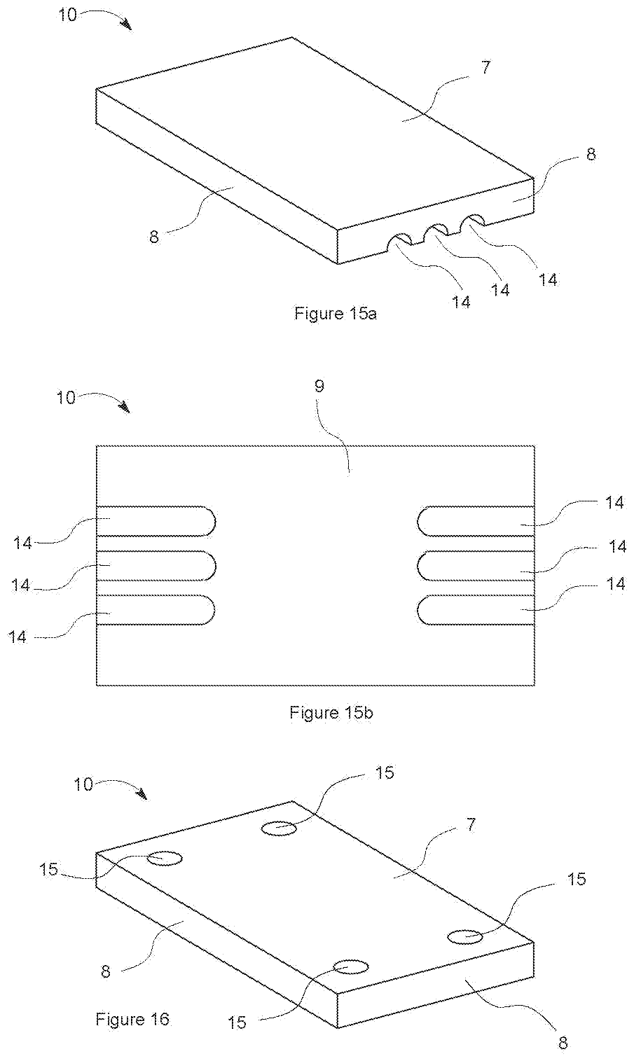

In some embodiments, illustrated in FIGS. 15a and 15b, the at least one indentation 14 is positioned at the edge of the downward facing surface 9. Incorporating the description (above) of the embodiment of FIGS. 17a and 17b, the at least one indentation 14 of FIGS. 15a and 15b may vary in number and position. Indeed, one skilled in the art will appreciate that the at least one indentation 14 as discussed above may be positioned in any applicable manner which allows a user to handle the cutting insert 10 with one or more finger/s.

In any of the embodiments of the presently disclosed cutting insert 10, it may be fashioned as one piece or fashioned out of portions connected/molded together. In some embodiments, the cutting insert 10, or a portion of it such as the upward facing surface 7, comprises wood, plastic, or any other material suitable for use with a sharp knife.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide. For example, when using the term “substantially” herein it may be a value of at least 50%, at least 60%, at least 70%, at least 80%, at least 90%, or at least 99%, or any amount or range therebetween.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A cutting insert designed for fitting in a food container lid, the cutting insert comprising:
an upward facing surface and downward facing surface;
a perimeter that extends between the upward facing surface and the downward facing surface.

2. The cutting insert of claim 1, wherein the upward facing surface and the downward facing surface are substantially planar.

3. The cutting insert of claim 1, wherein the cutting insert is of a predetermined shape; and wherein the predetermined shape is selected from a group comprising a square, rectangle, circle, or oval.

4. The cutting insert of claim 1, wherein the cutting insert is designed to have a predetermined thickness defined between the upward facing surface and downward facing surface.

5. The cutting insert of claim 1, wherein the downward facing surface is concave; and wherein the depression is centered at the center of the downward facing surface and conforms to the shape of the downward facing surface.

6. The cutting insert of claim 1, wherein the downward facing surface is concave; and wherein the depression is centered at the center of the downward facing surface and the shape of the depression id selected from a group comprising a square, rectangle, circle, or oval.

7. The cutting insert of claim 1, wherein the downward facing surface is coated with, or fashioned of, a material having a high coefficient of friction.

8. The cutting insert of claim 1, wherein the perimeter is coated with, or fashioned of, a material having a high coefficient of friction.

9. The cutting insert of claim 1, wherein the upward facing surface comprises at least one groove formed proximal to, and along, at least one portion of a perimeter of the upward facing surface.

10. The cutting insert of claim 1, wherein the upward facing surface comprises an arcuate groove formed proximal to, and along, a perimeter of the upward facing surface.

11. The cutting insert of claim 1, wherein the cutting insert comprises at least one aperture proximal to said cutting insert perimeter; the at least one aperture sized to receive one or more fingers of a user for installing and removing said cutting insert from the food container lid.

12. The cutting insert of claim 1, wherein at least one side of the perimeter comprises at least one indentation; the at least one indentation sized to receive one or more fingers of a user for installing and removing said cutting insert from the food container lid.

13. The cutting insert of claim 12, wherein the cutting insert is a square or a rectangle, two sides of the cutting insert, which are opposing and substantially parallel, each comprise said at least one indentation.

14. The cutting insert of claim 1, wherein at least one side of the downward facing surface comprises at least one indentation positioned at its edge; the at least one indentation sized to receive one or more fingers of a user for installing and removing said cutting insert from the food container lid.

15. The cutting insert of claim 14, wherein the cutting insert is a square or a rectangle, two sides of the downward facing surface, which are opposing and substantially parallel, comprise said at least one indentation.

16. A method of using the cutting insert of claim 1 to store and cut food, comprising the steps of:
a) placing the cutting insert inside the food container's lid so that the cutting insert is within the perimeter of the lid's inner rim;
b) placing a food item on the cutting insert;
c) releasably securing the food container lid to the food container body wherein food container is in an upside-down position, and thus storing the food inside the food container;
d) as needed, releasing the food container body from the food container lid to cut food placed on the cutting insert or to remove the cutting insert and food placed upon it from the food container lid.
